(19) United States
(12) Patent Application Publication
(10) Pub. No.: US 2017/0130283 A1
(43) Pub. Date: May 11, 2017

(54) Method For Preserving Hides or Skins

(71) Applicant: Lonza do Brasil Especialidades Quimicas Ltda, Sao Paulo (BR)

(72) Inventors: Mauricio da Silva Franzim, Sao Paulo (BR); Cleide Caldas Costa, Sao Paulo (BR); Viviane Alves da Silva, Sao Paulo (BR); Rafael Leandro Pedro, Sao Paulo (BR)

(21) Appl. No.: 15/341,109

(22) Filed: Nov. 2, 2016

Related U.S. Application Data
(60) Provisional application No. 62/251,347, filed on Nov. 5, 2015.

(51) Int. Cl. C14C 1/00; A01N 47/44; A01N 25/02; A01N 33/12

(52) U.S. Cl. CPC C14C 1/00; A01N 33/12; A01N 47/44; A01N 25/02

(57) ABSTRACT

A process for preserving raw/fresh hides and skins is disclosed. In one embodiment, the hides and skins are treated with an antimicrobial composition containing a carbonate and/or bicarbonate salt of a quaternary ammonium cation. Alternatively, the antimicrobial composition contains a halide salt of a quaternary ammonium cation in combination with a second antimicrobial agent which may comprise a polyhexamethylene biguanide. The compositions are capable of preventing microbial degradation of the raw skins and hides for significant periods of time, such as greater than 48 hours.

### RELATED APPLICATIONS

The present application is based on and claims priority to and is based upon U.S. Provisional Patent application Ser. No. 62/251,347, filed on Nov. 5, 2015, and which is incorporated herein by reference.

### BACKGROUND

During the production of leather goods, raw/fresh animal hides and skins are first collected from a slaughterhouse. The raw/fresh hides or skins are then stored and/or transported to a leather-making facility. Prior to being processed into leather, the hides and skins can be stored for an amount of time of from hours to weeks. Unfortunately, the hides and skins are very susceptible to microbial degradation as their main constituent is protein. Consequently, raw hides and skins begin to rot almost immediately.

The freshly stripped skin must be rendered storable, that is to say preserved, in order to avoid such damage by rotting. Various processes have been proposed in order to reduce damage caused by bacteria and to preserve the hides and skins.

Many of the known processes are used both for short-term preservation and for long-term preservation. The result is that these processes are often uneconomical for only short-term preservation, since the work expended and the use of chemicals are usually the same in both cases.

The oldest and most used preservation process is treatment of the rawhides with salt (sodium chloride) or brine. The salt reduces the water content of the hide from about 65% to 35-40% and thus provides a living atmosphere which is adverse to bacteria, so that bacteria growth is inhibited.

Although the use of salt as a preservative is still widely used and cost effective, the use of salt does present problems. For instance, the process produces copious amounts of concentrated salt solutions. These used salt solutions represent a major pollution issue and require carefully controlled processes in order to safely dispose of the solutions. In addition to creating pollution issues, the salt solutions are very corrosive and thus require equipment made from special metals and other materials in order to hold and transport the salt solutions.

In the past, various other chemicals have been proposed as preservatives for raw hides and skins. Most proposed chemicals, however, fail to preserve the skins and hides for more than 48 hours.

In view of the above, a need exists for an improved method for preserving raw/fresh hides and skins prior to the leather-making process.

### SUMMARY

In general, the present disclosure is directed to an improved method for preserving fresh/raw hides and skins. The method of the present disclosure can preserve the hides and skins for well over 48 hours.

In general, the present disclosure is directed to a method for preserving animal hides or skins by treating the hides or skins with an antimicrobial composition. The hides or skins treated in accordance with the present disclosure comprise raw or fresh hides or skins, such as hides or skins that have not begun the tanning and/or leather process. The antimicrobial composition can generally contain an antimicrobial agent, such as a salt of a quaternary ammonium cation. The antimicrobial composition can be initially formulated into a concentrate that is later diluted. Once diluted, the animal skins or hides can be treated by being immersed in a bath containing the antimicrobial composition. Alternatively, the animal hides or skins can be treated in any suitable manner, such as by spraying or other similar process.

In one particular embodiment of the present disclosure, the method includes treating the hides or skins with an antimicrobial composition that comprises a carbonate/bicarbonate salt of a quaternary ammonium cation. For instance, the antimicrobial agent may comprise a di C₈-C₁₂ alkyl ammonium carbonate/bicarbonate. In one particular embodiment, for instance, the antimicrobial agent may comprise didecyl dimethyl ammonium carbonate/bicarbonate. The antimicrobial agent may be combined with an alcohol, such as methanol or ethanol.

In the above embodiment, the carbonate/bicarbonate salt of a quaternary ammonium cation may be present in the antimicrobial composition concentrate in an amount from about 1% to about 80% by weight, such as in an amount from about 10% to about 70% by weight, such as in an amount from about 20% to about 60% by weight. The alcohol, on the other hand, may be present in the concentrate in an amount from about 0.3% to about 30% by weight, such as in an amount from about 1% to about 20% by weight.

In an alternative embodiment, the antimicrobial agent contained in the antimicrobial composition may comprise a halide salt of a quaternary ammonium cation, such as a chloride salt of a quaternary ammonium cation. The halide salt of the quaternary ammonium cation may be present alone or in combination with another antimicrobial agent. For instance, the second antimicrobial agent present in the composition may comprise a biguanide, such as polyhexamethylene biguanide. The halide salt of the quaternary ammonium cation may comprise a di C₈-C₁₂ alkyl ammonium chloride, such as didecyl dimethyl ammonium chloride.

In addition to the halide salt of a quaternary ammonium chloride and a polyhexamethylene biguanide, the antimicrobial composition may further contain one or more surfactants and optionally water. The surfactant may comprise an anionic surfactant, a cationic surfactant, and/or a zwitterionic surfactant. Particular surfactants that may be present include ethoxylated alcohols, such as a lauryl alcohol ethoxylate containing 2 to 10, and particularly 5 to 9 mols of ethoxylate. Another surfactant that may be present is dipropylene glycol, which may also serve as a solvent.

In one particular embodiment, the antimicrobial composition as a concentrate comprises from about 1.5% to about 30% by weight of polyhexamethylene dimethyl ammonium chloride, from about 4% to about 80% by weight of polyhexamethylene biguanide, from about 0.5% to about 50% by weight of an ethoxylated alcohol, from about 0.8% to about 16% by weight of dipropylene glycol, from about 3% to about 60% by weight of water, and from about 0.5% to about 20% by weight of ethanol.

As described above, the antimicrobial composition may initially be formulated as a concentrate that is then diluted and applied to the animal skins and hides. In one embodiment, the concentrate is diluted such that the antimicrobial composition is present in water at a concentration of from about 5 ppm to about 1,000 ppm, such as from about 5 ppm to about 500 ppm, such as from about 5 ppm to about 50 ppm. In one embodiment, the concentration can be from about 8 ppm to about 40 ppm.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a method for preserving raw/fresh hides and skins. More particularly, the present disclosure is directed to chemical formulations and to a method for protecting animal hides and skins from microbial degradation after slaughter and during shipping and storage prior to producing leather goods. In accordance with the present disclosure, the hides and skins are treated with an antimicrobial composition that contains a salt of a quaternary ammonium cation. In addition, the antimicrobial composition may contain an alcohol, an additional antimicrobial agent, and one or more surfactants. The method of the present disclosure can preserve fresh hides and skins for greater than 48 hours, such as from two days to seven days.

In one embodiment of the present disclosure, the antimicrobial composition comprises a salt of a quaternary ammonium cation and particularly a carbonate and/or bicarbonate salt of a quaternary ammonium cation. In this embodiment, the antimicrobial composition may further contain an alcohol, such as methanol or ethanol. In one embodiment, the antimicrobial composition only contains a carbonate and/or bicarbonate salt of a quaternary ammonium cation, an alcohol, and water. It was discovered that a carbonate and/or bicarbonate salt of a quaternary ammonium salt unexpectedly and dramatically inhibits microbial degradation of fresh hides and skins. Of particular advantage, it was discovered that treating hides and skins with a carbonate and/or bicarbonate salt of a quaternary ammonium cation can have long-lasting antimicrobial effects on the hides and skins.

A quaternary ammonium carbonate can be represented by the following formula:

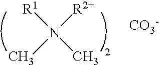

wherein R¹ is a C₁-C₂ alkyl or aryl-substituted alkyl group and R² is a C₈-C₂₀ alkyl group, and preferably wherein R¹ is the same as R² and R¹ is a C₈-C₁₂ alkyl group, as well as compositions further comprising the corresponding quaternary ammonium bicarbonate

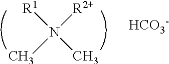

wherein R¹ is the same or a different C₁-C₂₀ alkyl or aryl-substituted alkyl group as above and R² is the same or a different C₈-C₂₀ alkyl group as above, but preferably wherein R¹ is the same as R² and R¹ is a C₈-C₁₂ alkyl group.

In one embodiment, the antimicrobial agent contained in the antimicrobial composition comprises a di C₈-C₁₂ alkyl ammonium carbonate/bicarbonate. For example, in one particular embodiment, the antimicrobial composition contains didecyl dimethyl ammonium carbonate and didecyl dimethyl ammonium bicarbonate.

In other embodiments, however, the carbonate/bicarbonate salts of quaternary ammonium cations may be selected from dioctyldimethylammonium carbonate, decyloctyldimethylammonium carbonate, benzalkonium carbonate, benzethonium carbonate, stearalkonium carbonate, cetrimonium carbonate, behentrimonium carbonate, dioctyldimethylammonium bicarbonate, decyloctyldimethylammonium bicarbonate, benzalkonium bicarbonate, benzethonium bicarbonate, stearalkonium bicarbonate, cetrimonium bicarbonate, behentrimonium bicarbonate, and mixtures of one or more such carbonate salts.

As described above, in one embodiment, the antimicrobial composition comprises a carbonate and/or bicarbonate salt of a quaternary ammonium cation in combination with an alcohol. The alcohol may comprise, for instance, a C₁-C₆ alcohol, such as methanol and/or ethanol.

In accordance with the present disclosure, the antimicrobial composition may be formulated as a concentrate that is then diluted with water in treating animal hides and skins. The antimicrobial composition concentrate, for instance, may contain carbonate and/or bicarbonate salts of quaternary ammonium cations in an amount greater than about 5% by weight, such as greater than about 10% by weight, such as greater than about 15% by weight, such as greater than about 20% by weight, such as greater than about 25% by weight, such as greater than about 30% by weight, such as greater than about 35% by weight, such as greater than about 40% by weight, such as greater than about 45% by weight, such as greater than about 50% by weight, such as greater than about 55% by weight, such as greater than about 60% by weight. In general, the carbonate and/or bicarbonate salts of the quaternary ammonium cations are present in the concentrate in an amount less than about 80% by weight, such as in an amount less than about 75% by weight, such as in an amount less than about 70% by weight, such as in an amount less than about 65% by weight, such as in an amount less than about 60% by weight, such as in an amount less than about 55% by weight, such as in an amount less than about 50% by weight, such as in an amount less than about 45% by weight, such as in an amount less than about 40% by weight. One or more alcohols may be present in the antimicrobial composition concentrate in an amount greater than about 0.3% by weight, such as in an amount greater than about 0.5% by weight, such as in an amount greater than about 1% by weight, such as in an amount greater than about 3% by weight, such as in an amount greater than about 5% by weight, such as in an amount greater than about 10% by weight, such as in an amount greater than about 15% by weight. One or more alcohols can be present in the concentrate generally in an amount less than about 30% by weight, such as in an amount less than about 25% by weight, such as in an amount less than about 20% by weight.

In other embodiments, the antimicrobial composition of the present disclosure may contain other salts of quaternary ammonium cations either alone or in combination with the carbonate/bicarbonate salts. For instance, in an alternative embodiment of the present disclosure, the antimicrobial agent contained in the antimicrobial composition comprises a halide salt of a quaternary ammonium cation. In one particular embodiment, for instance, the antimicrobial agent may comprise a chloride salt of a quaternary ammonium cation. The halide salt, for instance, may comprise a di C₈-C₁₂ alkyl ammonium chloride. In one particular embodiment, for instance, the antimicrobial agent comprises didecyl dimethyl ammonium chloride.

When the antimicrobial composition contains a halide salt of a quaternary ammonium cation, in further embodiments, a second antimicrobial agent may be contained in the composition. For example, in one embodiment, the second antimicrobial composition may comprise a guanidine, and particularly a polymeric biguanide. For example, in one embodiment, the second antimicrobial agent may comprise polyhexamethylene biguanide, such as polyhexamethylene biguanide hydrochloride (commonly known as PHMB's).

PHMB is commonly represented by the following formula, though it is known to exist as a complex mixture of polymeric biguanides with various terminal groups including guanidine (not shown).

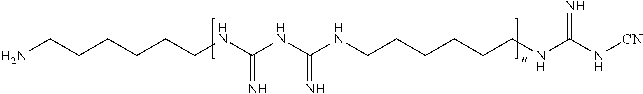

The value n represents the number of repeating units of the biguanide polymer.

More particularly, PHMB can be a mixture of various biguanide polymers that can include different combinations of terminal groups, e.g., amine, cyanoguanidino, and guanidine. Based only on these three terminal groups, at least six possible biguanide polymers can exist. There can be one biguanide polymer with two terminal amine groups, which is referred to as PHMB-AA, one with two terminal cyanoguanidino groups, which is referred to as PHMB-CGCG, and one with two terminal guanidine groups, which is referred to as PHMB-GG (see, below). There are also the three possible biguanide polymers having a combination of two different terminal groups. Again, based on the above terminal groups they include amine-cyanoguanidino (PHMB-ACG), amine-guanidino (PHMB-AG) and guanidine-cyanoguanidino (GCG). Accordingly, a sample of PHMB may comprise a mixture of polymeric biguanides with the three mentioned terminal groups. Moreover, some of the composition can include in-chain polymeric guanide (not shown). The subscript “n” represents the average number of repeating groups, and a distribution of polymer length exists for each of the polymers shown below.

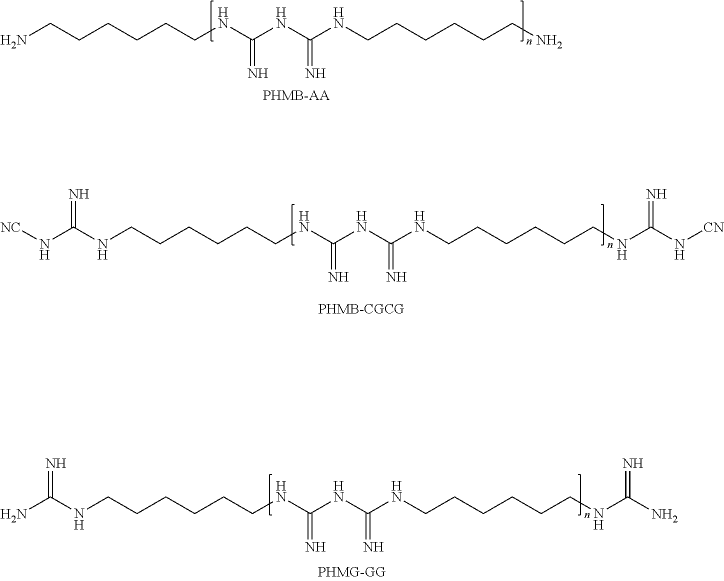

wherein n can be from about 1 to about 50, such as from about 1 to about 20. Polyhexamethylene biguanides that may be used in compositions of the present disclosure include those identified under CAS #'s 27083-27-8, 32289-58-0, 91403-50-8, r32289-58-0, 1802181-67-4 and mixtures thereof.

Polyhexamethylene biguanide, such as polyhexamethylene biguanide hydrochloride has a broad antimicrobial range and is fast acting. Further, the antimicrobial agent is stable over a broad pH range and can work in conjunction with a salt of a quaternary ammonium cation.

In one particular embodiment of the present disclosure, the antimicrobial composition contains a combination of a chloride salt of a quaternary ammonium cation in conjunction with a polyhexamethylene biguanide, and particularly a polyhexamethylene biguanide hydrochloride. The antimicrobial composition can be formulated as a concentrate for later dilution prior to application to the hides or skins. The chloride salt of the quaternary ammonium cation can be present in the concentrate in an amount greater than about 1.5% by weight, such as in an amount greater than about 3% by weight, such as in an amount greater than about 5% by weight, such as in an amount greater than about 7% by weight, such as in an amount greater than about 10% by weight, such as in an amount greater than about 12% by weight, such as in an amount greater than about 15% by weight, such as in an amount greater than about 17% by weight, such as in an amount greater than about 20% by weight. The chloride salt of the quaternary ammonium cation can generally be present in an amount less than about 30% by weight, such as in an amount less than about 25% by weight, such as in an amount less than about 23% by weight, such as in an amount less than about 20% by weight. The polyhexamethylene biguanide may be present in the concentrate in an amount greater than the salt of the quaternary ammonium cation. In general, the polyhexamethylene biguanide may be present in the concentrate in an amount greater than about 4% by weight, such as in an amount greater than about 8% by weight, such as in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight. The polyhexamethylene biguanide is generally present in an amount less than about 80% by weight, such as in an amount less than about 75% by weight, such as in an amount less than about 70% by weight, such as in an amount less than about 65% by weight, such as in an amount less than about 60% by weight, such as in an amount less than about 55% by weight, such as in an amount less than about 50% by weight, such as in an amount less than about 45% by weight, such as in an amount less than about 40% by weight. In addition, the concentrate may contain an alcohol, such as ethanol or methanol. The alcohol can be present in an amount greater than about 0.5% by weight, such as in an amount greater than about 2% by weight, such as in an amount greater than about 5% by weight, such as in an amount greater than about 7% by weight. The alcohol is generally present in an amount less than about 20% by weight, such as in an amount less than about 15% by weight, such as in an amount less than about 10% by weight.

In the above embodiments, the antimicrobial composition may further contain various other ingredients. For instance, the antimicrobial composition can contain one or more surfactants and optionally water.

Surfactants that may be included in the antimicrobial composition include nonionic surfactants, cationic surfactants, zwitterionic surfactants, and mixtures thereof. Non-limiting examples of surfactants include amine oxides, linear alcohol alkoxylates, secondary alcohol alkoxylates, alkoxylate ethers, betamines, and mixtures thereof.

Water soluble nonionic surfactants include the primary aliphatic alcohol ethoxylates, secondary aliphatic alcohol ethoxylates, alkylphenol ethoxylates and ethylene-oxide-propylene oxide condensates of primary alkanols. The nonionic synthetic organic surfactants generally are the condensation products of an organic aliphatic or alkyl aromatic hydrophobic compound and hydrophilic ethylene oxide groups. Practically any hydrophobic compound having a carboxy, hydroxy, amido, or amino group with a free hydrogen attached to the nitrogen can be condensed with ethylene oxide or with the polyhydration product thereof, polyethylene glycol, to form a water-soluble nonionic surfactant. Further, the length of the polyethenoxy chain can be adjusted to achieve the desired balance between the hydrophobic and hydrophilic elements.

The nonionic surfactant class includes the condensation products of a higher alcohol (e.g., an alkanol containing about 8 to 18 carbon atoms in a straight or branched chain configuration) condensed with about 5 to 30 moles of ethylene oxide, for example, lauryl or myristyl alcohol condensed with about 5 to 20 moles of ethylene oxide (EO), tridecanol condensed with about 6 to moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

Additional satisfactory water soluble alcohol ethylene oxide condensates are the condensation products of a secondary aliphatic alcohol containing 8 to 18 carbon atoms in a straight or branched chain configuration condensed with 5 to 30 moles of ethylene oxide. Examples of nonionic surfactants of the foregoing type are C₁₁-C₁₅ secondary alkanol condensed with either 9 EO or 12 EO.

Other suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include nonyl phenol condensed with about 9.5 moles of EO per mole of nonyl phenol, dinonyl phenol condensed with about 12 moles of EO per mole of phenol, dinonyl phenol condensed with about 15 moles of EO per mole of phenol and di-isoctylphenol condensed with about 15 moles of EO per mole of phenol.

Also among the satisfactory nonionic surfactants are the water-soluble condensation products of a C₈-C₂₀ alkanol with a heteric mixture of ethylene oxide and propylene oxide wherein the weight ratio of ethylene oxide to propylene oxide is from 2.5:1 to 4:1, preferably 2.8:1 to 3.3:1, with the total of the ethylene oxide and propylene oxide (including the terminal ethanol or propanol group) being from 60-85%, preferably 70-80%, by weight. A particularly preferred surfactant is a C₁₀-C₁₆ alkanol condensate with ethylene oxide and propylene oxide, the weight ratio of ethylene oxide to propylene oxide being 3:1 and the total alkoxy content being about 75% by weight.

Condensates of 2 to 30 moles of ethylene oxide with sorbitan mono- and tri-C₁₀-C₂₀ alkanoic acid esters having a HLB of 8 to 15 also may be employed as the nonionic surfactant in the described composition. Suitable surfactants include polyoxyethylene (4) sorbitan monolaurate, polyoxyethylene (4) sorbitan monostearate, polyoxyethylene (20) sorbitan trioleate and polyoxyethylene (20) sorbitan tristearate.

Other suitable water-soluble nonionic surfactant compounds are formed by condensing ethylene oxide with a hydrophobic base formed by the condensation of propylene oxide with propylene glycol. The molecular weight of the hydrophobic portion of the molecule is of the order of 950 to 4000 and preferably 200 to 2,500. The addition of polyoxyethylene radicals to the hydrophobic portion tends to increase the solubility of the molecule as a whole so as to make the surfactant water-soluble. The molecular weight of the block polymers varies from 1,000 to 15,000 and the polyethylene oxide content may comprise 20% to 80% by weight.

In one embodiment, the antimicrobial composition may contain a compound that may serve as a surfactant and also as a solvent. For example, suitable water soluble solvents for the composition are water-soluble polyethylene glycols having a molecular weight of 150 to 1000, polypropylene glycol of the formula HO(CH₃CHCH₂O)ₙH wherein n is a number from 2 to 18, mixtures of polyethylene glycol and polypropyl glycol and mono and di C₁-C₆ alkyl ethers and esters of ethylene glycol and propylene glycol having the structural formulas R(X)ₙOH R₁(X)ₙOH R(X)ₙOR and R₁(X)ₙOR₁ wherein R is C₁-C₆ alkyl group, R₁ is C₂-C₄ acyl group, X is (OCH₂CH₂) or (OCH₂(CH₃)CH) and n is a number from 1 to 4, diethylene glycol, triethylene glycol, an alkyl lactate, wherein the alkyl group has 1 to 6 carbon atoms, 1 methoxy-2-propanol, 1 methoxy-3-propanol, and 1methoxy 2-, 3- or 4-butanol.

Representative members of the polypropylene glycol group include dipropylene glycol and polypropylene glycol having a molecular weight of 150 to 1000, e.g., polypropylene glycol 400. Other satisfactory glycol ethers are ethylene glycol monobutyl ether, diethylene glycol monobutyl ether, triethylene glycol monobutyl ether, mono, di, tri propylene glycol monobutyl ether, tetraethylene glycol monobutyl ether, mono, di, tripropylene glycol monomethyl ether, propylene glycol monomethyl ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono, di, tripropylene glycol monoethyl ether, mono, di tripropylene glycol monopropyl ether, mono, di, tripropylene glycol monopentyl ether, mono, di, tripropylene glycol monohexyl ether, mono, di, tributylene glycol mono methyl ether, mono, di, tributylene glycol monoethyl ether, mono, di, tributylene glycol monopropyl ether, mono, di, tributylene glycol monobutyl ether, mono, di, tributylene glycol monopentyl ether and mono, di, tributylene glycol monohexyl ether, ethylene glycol monoacetate and dipropylene glycol propionate.

When the antimicrobial composition contains a surfactant, such as an ethoxylated alcohol, the surfactant can be present in the antimicrobial composition concentrate in an amount greater than about 0.5%, such as in an amount greater than about 2%, such as in an amount greater than about 4%, such as in an amount greater than about 8%, such as in an amount greater than about 10%, such as in an amount greater than about 12%, such as in an amount greater than about 15%, such as in an amount greater than about 18%, such as in an amount greater than about 20%, such as in an amount greater than about 23%, such as in an amount greater than about 25%, such as in an amount greater than about 28%, such as in an amount greater than about 30%. The ethoxylated alcohol or nonionic surfactant can generally be present in the concentrate in an amount less than about 50% by weight, such as in an amount less than about 45% by weight, such as in an amount less than about 40% by weight, such as in an amount less than about 35% by weight, such as in an amount less than about 30% by weight.

A surfactant/solvent, such as dipropylene glycol, can be present in the concentrate in an amount greater than about 0.8% by weight, such as in an amount greater than about 1% by weight, such as in an amount greater than about 2% by weight, such as in an amount greater than about 3% by weight, such as in an amount greater than about 5% by weight, such as in an amount greater than about 7% by weight, such as in an amount greater than about 10% by weight. The dipropylene glycol may generally be present in an amount less than about 16% by weight, such as in an amount less than about 14% by weight, such as in an amount less than about 12% by weight, such as in an amount less than about 10% by weight, such as in an amount less than about 8% by weight.

In one embodiment, the antimicrobial composition comprises a chloride salt of a quaternary ammonium cation in an amount from about 1.5% to about 30% by weight, contains a polyhexamethylene biguanide in an amount from about 4% to about 80% by weight, contains an ethoxylated alcohol, such as an ethoxylated lauryl alcohol containing 7 mols of ethoxylate in an amount from about 0.5% to about 50% by weight, contains dipropylene glycol in an amount from about 0.8% to about 16% by weight, contains an alcohol, such as ethanol in an amount from about 0.1% to about 10% by weight, and also optionally contains water. Water can be present in the antimicrobial composition concentrate generally in an amount from about 3% to about 60% by weight, such as from about 10% to about 40% by weight.

In order to treat hides and skins in accordance with the present disclosure, in one embodiment, the antimicrobial composition is initially formulated as a concentrate and then diluted with water prior to application to the hides or skins. The concentrate is diluted using a biocidal effective amount or concentration of one or more antimicrobial agents. A biocidal effective amount is an amount effective to inhibit the growth of or to kill one or more microorganisms that may cause rot or other microbial degradation. In one embodiment, the concentration of the one or more antimicrobial agents may be greater than about 5 ppm, such as greater than about 20 ppm, such as greater than about 100 ppm, such as greater than about 500 ppm, such as greater than about 1,000 ppm, such as greater than about 1,500 ppm, such as greater than about 2,000 ppm, such as greater than about 4,000 ppm, such as greater than about 6,000 ppm, such as greater than about 8,000 ppm, such as greater than about 10,000 ppm, such as greater than about 12,000 ppm, such as greater than about 14,000 ppm, such as greater than about 16,000 ppm, such as greater than about 18,000 ppm, such as greater than about 20,000 ppm. The concentration of the one or more antimicrobial agents is generally less than about 50,000 ppm, such as less than about 40,000 ppm, such as less than about 30,000 ppm, such as less than about 25,000 ppm. In one embodiment, the one or more antimicrobial agents may be present in the diluted composition in an amount from about 2,000 ppm to about 30,000 ppm.

The manner in which the antimicrobial composition is applied to the hides or skins can vary depending upon the particular application. For instance, treatment of the hides or skins can be accomplished by any suitable method such as dipping, soaking, brushing, pressure treating, spraying, or the like.

The present disclosure may be better understood with reference to the following example.

### Example No. 1

Various rawhides were treated with different antimicrobial compositions and compared to an untreated control. The antimicrobial formulations included the following concentrates:

### Sample No. 1

didecyl dimethyl ammonium carbonate/bicarbonate 50 wt. %
methanol 3 wt. %
water 47 wt %

### Sample No. 2

Polyhexamethylene biguanide hydrochloride 40 wt. %
didecyl dimethyl ammonium chloride 15 wt. %
lauryl alcohol ethoxylate containing 7 mols of ethylene oxide 5.70 wt. %
water 30.90 wt. %
dipropylene glycol 8.40 wt. %

### Sample No. 3

### Dithiocarbamate 50 wt. %

water 50 wt. %

Sample No. 3 containing dithiocarbamate was used as comparison. Dithiocarbamate is currently being used to treat raw hides.

The above formulations were contacted with raw hides, particularly black hair cow raw hides.

Each antimicrobial composition was diluted to 10 grams per liter and to 20 grams per liter. The hides were immersed in a bath containing the above antimicrobial compositions for 3 mins. The presence of microorganisms was then tested after 24 hours, 48 hours and 72 hours. In particular, a standard method was used to quantify the number of total and halophilic bacteria in the hide, water bath and supplies. The procedure followed was ABNT NBR 14239:2013—Peles, Banho Residual e Insumos-Contagem de Bacterias Totais e/ou Halofilicas. In conducting the test, 10 grams of hide was placed in 100 ml of diluent and serial diluted. The natural bacterial contaminants are recovered and compared to untreated hides.

The following results were obtained:

Condition test: Immersion for 3 min/dosage 10 g/L

Contact

| time | Leather - black haired cow | | | |
|---|---|---|---|---|
| (hours) | Control | Sample No. 1 | Sample No. 2 | Sample No. 3 |
| T24 | 1.21E+06 | 2.42E+03 | 2.32E+03 | 1.53E+05 |
| T48 | 3.64E+06 | 2.80E+03 | 1.12E+04 | 1.26E+04 |
| T72 | 4.44E+06 | 4.56E+03 | 1.93E+05 | 3.19E+05 |

Condition test: Immersion for 3 min/dosage 20 g/L

Contact

| time | Leather - black haired cow | | | |
|---|---|---|---|---|
| (hours) | Control | Sample No. 1 | Sample No. 2 | Sample No. 3 |
| T24 | 1.21E+06 | 7.00E+01 | 2.55E+02 | 2.09E+04 |
| T48 | 3.64E+06 | 5.65E+02 | 1.75E+03 | 2.84E+04 |
| T72 | 4.44E+06 | 2.21E+03 | 5.59E+04 | 2.50E+05 |

As shown above, compositions made in accordance with the present disclosure dramatically and unexpectedly controlled microbial degradation in comparison to the control and in comparison to the use of dithiocarbamate.

### Example No. 2

Various rawhides were treated with different antimicrobial compositions and compared to an untreated control similar to Example No. 1 above. The antimicrobial formulations included the following concentrates:

### Sample No. 4

Polyhexamethylene biguanide hydrochloride 40 wt. %
didecyl dimethyl ammonium chloride 15 wt. %
lauryl alcohol ethoxylate containing 7 mols of ethylene oxide 5.70 wt. %
water 30.90 wt. %
dipropylene glycol 8.40 wt. %

### Sample No. 5

didecyl dimethyl ammonium carbonate/bicarbonate 50 wt. %
methanol 3 wt. %
water 47 wt %

Each antimicrobial composition was diluted to 10 grams per liter. The hides were immersed in a bath containing the above antimicrobial compositions for 3 mins. After treatment, the hides were removed from the bath and stored at room temperature. The presence of microorganisms was then tested after 1 hour, 24 hours, 48 hours and 72 hours. In particular, a standard method was used to quantify the number of total and halophilic bacteria in the hide, water bath and supplies. The procedure followed was ABNT NBR 14239:2013—Peles, Banho Residual e Insumos-Contagem de Bactérias Totais e/ou Halofilicas. In conducting the test, 10 grams of hide was placed in a saline-tween solution, filtered, and fed to serial dilution. Samples were placed on TSA agar (with 0.5% salt concentration). Plates were incubated for 48 hours at 35±2° C. Colonies were counted and results compared to untreated hide pieces.

The following results were obtained:

Condition test: Immersion for 3 min/dosage 10 g/L

| Contact | Leather | | | | |
|---|---|---|---|---|---|
| time | | Sample | Sample | Sample | Sample |
| (hours) | Control | No. 4 | No. 4 | No. 5 | No. 5 |
| T1 | 1.27E+05 | 8.00E+01 | 1.80E+02 | 1.00E+01 | 4.00E+01 |
| T24 | 1.40E+06 | 1.30E+02 | 2.25E+02 | 3.00E+01 | 6.00E+01 |
| T48 | 4.10E+06 | 9.00E+01 | 6.65E+02 | 5.00E+01 | 4.00E+01 |
| T72 | 4.35E+07 | 2.85E+02 | 3.05E+02 | 6.00E+01 | 9.00E+01 |

As shown above, compositions made in accordance with the present disclosure dramatically and unexpectedly controlled microbial degradation in comparison to the control. Samples made according to the present disclosure were effective in controlling the microbial contamination in hides under levels of 10³ colony forming units per grams of hide.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method for preserving animal hides or skins comprising treating the hides or skins with an antimicrobial composition, the antimicrobial composition containing one or more antimicrobial agents comprising a salt of a quaternary ammonium cation, the salt of a quaternary ammonium cation comprising:
a) a carbonate/bicarbonate salt of a quaternary ammonium cation; or
b) a halide salt of a quaternary ammonium cation combined with a surfactant.

2. A method as defined in claim 1, wherein the salt of a quaternary ammonium cation comprises the carbonate/bicarbonate salt of a quaternary ammonium cation.

3. A method as defined in claim 1, wherein the salt of a quaternary ammonium cation comprises at least one di C₈-C₁₂ alkyl ammonium carbonate/bicarbonate.

4. A method as defined in claim 1, wherein the salt of a quaternary ammonium cation comprises didecyl dimethyl ammonium carbonate/bicarbonate.

5. A method as defined in claim 1, wherein the antimicrobial composition comprises a concentrate, the salt of a quaternary ammonium cation being present in the concentrate in an amount of from 1% to about 80% by weight, and wherein the method further includes the step of diluting the concentrate prior to treating the hides or skins with the antimicrobial composition.

6. A method as defined in claim 5, wherein the salt of a quaternary ammonium cation is contained in the concentrate in an amount from about 30% to about 80% by weight.

7. A method as defined in claim 1, wherein the salt of a quaternary ammonium cation comprises the halide salt of a quaternary ammonium cation.

8. A method as defined in claim 1, wherein the salt of a quaternary ammonium cation comprises a di C₈-C₁₂ alkyl ammonium chloride.

9. A method as defined in claim 1, wherein the microbial composition further contains polyhexamethylene biguanide.

10. A method as defined in claim 9, wherein the antimicrobial composition comprises a concentrate that is diluted when the animal hides or skins are treated, the polyhexamethylene biguanide being present in the concentrate in an amount from about 4% to about 80% by weight.

11. A method as defined in claim 1, wherein the antimicrobial composition further comprises a nonionic surfactant.

12. A method as defined in claim 11, wherein the surfactant comprises an ethoxylated alcohol.

13. A method as defined in claim 1, wherein the antimicrobial composition further comprises dipropylene glycol.

14. A method as defined in claim 11, wherein the antimicrobial composition comprises a concentrate that is later diluted when treating the hides or skins, the concentrate containing the surfactant in an amount from about 0.5% to about 50% by weight.

15. A method as defined in claim 1, wherein the antimicrobial composition comprises a concentrate that is later diluted when treating the hides or skins, the salt of a quaternary ammonium cation comprising didecyl dimethyl ammonium chloride present in the concentrate in an amount from about 1.5% to about 30% by weight, the alcohol comprising ethanol, the antimicrobial composition concentrate further containing polyhexamethylene biguanide in an amount from about 4% to about 80% by weight, an ethoxylated alcohol surfactant in an amount from about 0.5% to about 50% by weight, water in an amount from about 3% to about 60% by weight, and dipropylene glycol in an amount from about 0.8% to about 16% by weight.

16. A method as defined in claim 1, wherein the antimicrobial composition comprises a concentrate that is diluted prior to treating the hides or skins, the salt of a quaternary ammonium cation comprising didecyl dimethyl ammonium carbonate/bicarbonate being present in the concentrate in an amount from about 5% to about 80% by weight, the concentrate further containing the alcohol in an amount from about 0.3% to about 30% by weight, the alcohol comprising methanol.

17. A method as defined in claim 1, wherein the antimicrobial composition comprises a concentrate that is diluted prior to treating the hides or skins, the antimicrobial composition concentrate being diluted such that the one or more antimicrobial agents are present in the diluted composition in an amount from about 2,000 ppm to about 30,000 ppm.

18. A method as defined in claim 1, wherein the hides or skins are treated by immersing the hides or skins in a bath containing the antimicrobial composition.

19. A method as defined in claim 1, wherein the hides or skins are treated with the antimicrobial composition by spraying the antimicrobial composition onto the hides or skins.

20. A method as defined in claim 1, wherein the hides or skins are stored for at least 48 hours prior to being processed into leather.

21. A method as defined in claim 1, wherein the antimicrobial composition further contains an alcohol.
